(19) United States
(12) Patent Application Publication
(10) Pub. No.: US 2012/0195786 A1
(43) Pub. Date: Aug. 2, 2012

(54) PRODUCTION OF SPHEROIDAL METAL PARTICLES

(75) Inventors: Harald Eibisch, Boehmfeld (DE); Michael Grimm, Buttenheim (DE); Mathias Gruber, Geratskirchen (DE); Mark Hartmann, Kempten (DE); Andreas Lohmueller, Fuerth (DE); Michael Loos, Feucht (DE)

(73) Assignee: NON FERRUM GMBH, St. Georgen bei Salzburg (AT)

(21) Appl. No.: 13/203,145

(22) PCT Filed: Feb. 25, 2010
(86) PCT No.: PCT/DE10/00324

§ 371 Date: Apr. 11, 2012

(30) Foreign Application Priority Data
Feb. 25, 2009 (DE) 10 2009 010 600.6

(51) Int. Cl. B32B 15/02; C22C 23/00; B22F 9/08

(52) U.S. Cl. 420/402; 75/338; 425/7

(57) ABSTRACT

An apparatus and method for producing spheroidal metal particles having high size and shape uniformity from a melt from a highly reactive metal melt, with the following steps: melting the metal starting material under a hermetic seal; transporting the metal melt in a closed granulating tube from the melting furnace to at least one melt outlet; discharging the metal from the metal outlet via a rotary plate in the form of discrete drops to a melt stream which disintegrates into drops by the time it strikes the rotary plate; conducting a shielding gas flow into the region of the melt exiting from the melt outlet, collecting the melt on the rotary plate in the form of discrete melt drop, solidifying the melt drops into granule particles by contact with the colder surface of the rotary plate, and conducting the granule particles off the rotary plate for packaging/further processing.

### BACKGROUND OF THE INVENTION

1. Field of the Invention

The invention relates to an apparatus for producing spheroid metal particles with high size and shape uniformity; a process for producing spherical metal particles with high size and shape uniformity and the use of the process.

2. Description of Related Art

Further the invention comprises the granulate, produced by the process, the apparatus and systems of the invention. The thus produced granulate particles are suited in particular, e.g., for applications in which a particular flowability of the granulate—preferably without the formation of grit or particles of smaller grain size are desired, as for thixo molding.

The melting of metals with impurities such as metal oxides, metal nitrides, metal silicides, compositions thereof or foreign metal parts and typical additions are the typical raw materials for the production of metal granulates. In this context, in particular in case of magnesium and similar ignoble metals by reactions with the atmosphere in the melting furnace and with the melting crucible material, if this is solubilized by the melted mass or if the material thereof chips, and oxides or nitrides obstruct the outlets of the melted mass. Also some impurities in case of magnesium, for example its oxides are heavier than fluid metal so that they sink in the melting mass and deposit on the floor or on flow restrictions like on an outlet or cooler areas of an apparatus. By reactions with the crucible material of the furnace intermetallic phases would also be formed which can also accumulate in this sump. All these obstruct outlet openings, congest conducts causing an uneven composition of the granulate.

Generally speaking, there are two possibilities for the production of metal powder:

a) mechanical processes in which particles are produced by the machining or granulation of melt pieces; and

b) melting process in which small drops of the melting mass freeze and then form particles.

### Mechanical Process

A mechanical granulation device or machining device can produce particles with a fine structure, even if the spherical structure causing a reduced internal friction of the granulate during pouring, material conveying and pressing is missing. This kind of particles often shows a bad uniformity of the grain dimensions and form and of course, they are not spheroid. Furthermore, it is expensive, or even impossible, to produce granulates with grains as round as possible by mechanical granulation. Finally, this process is also expensive because the mechanical machining of ingots and similar is expensive and there is much remaining non-machined material, which must be funnelled back into the melting process. Metal granulates produced by the machining process also often show an irregular composition because irregular structures, like inclusions of the ingot are transferred into the powder.

In particular, a high quote of fine particles is created (<0.8 mm). In the injection-molding machine, these small particles can be crammed between the lands of the extruder screw and the cylinder. The consequence is an it regular rotation of the screw because of the oscillations of the torsional moment. This can cause irregular dosing. In addition, the fine particles entail an increased explosion risk. During the transport of the granulate the granulate may get de-mixed and the fine part increase. A further amount of fine particles can be formed by friction of the angular grains of the granulate aggravating the problem mentioned above. In addition, a formation of grains with a superior dimension than the one of the screw channel depth in the feeder area is possible. This phenomenon can cause the scres to get jammed.

### Melting Process

Conventional devices and processes for the production of granulate and/or powder from molten material apply atomization wherein the molten metal—frequently mixed with gas—is explosively atomized from a nozzle with high speed causing quite spattered parts or deliver spherical bodies by the so called rotating disc process wherein the metal melt drops from a melt container or furnace on a rotating disc and is spinned away while cooling-down, preferably against an ascending gas stream which reduces the falling speed of the droplets and flattens their longitudinal drop shape during the fall. By the process, relatively spherical particles are produced. It was also found that the small spheres produced by the melting process form an essentially finer grain structure compared to the parts produced by pulverized lying ingots which has been shown to be particularly preferable for metal injection molding (Czerwinski F., Materials Science and Engineering A 367, 2004, pages 261-271).

Metals which are very reactive in molten state, like magnesium and its alloys, which are increasingly desired as light metals and are frequently produced from magnesium die casting scrap are problematic because they are highly reactive in the melting mass. A potential problem for example is that the outlets for the fluid magnesium from the melt containers—a nozzle or a simple outlet tube—can be easily obstructed by the oxides formed by the melt leading to interruptions of production.

Conventional rotating disc devices for the production of small metal spheres comprise means to melt the metal and to cast the metal on a rotating basis, which spins the molten material by creating spheroid particles. Compare for example JP 51-64456, JP 07-179912, JP 63-33508 and JP 07-173510. Such kind of typical rotating disc devices produce spheroid powders of a relatively poor spherical characteristic, of limited micro dimensions and of a uniformity of the composition and shape to be improved.

### SUMMARY OF THE INVENTION

As a consequence, it is the object of the present to improve the production of spheroid metal granulates like of light metal and in particular of alkaline earth metals.

The object is attained according to the invention by an apparatus, a process, and a magnesium granulate as described herein.

According to the invention the molten metal is conveyed from a melting furnace through a granulating tube (5) to the melt outlet openings (16) into a granulation chamber (20).

In addition the device is equipped with a granulation rotating disc (1) under the granulation tube (5) which is equipped as least with one outlet for a molten metal jet onto a rotating disc (1), wherein the rotating disc (1) receives the molten metal dropping from the at least one outlet of the granulation tube (5) in the shape of spherical drops. The molten drops solidify to granulate particles (12) on the cold surface of the rotating disc. A protection gas-feeding device (15) feeds particularly selected gas to the molten metal jet coming from the molten metal outlet openings (16) into a granulation chamber (20) so to avoid the contact of the molten metal jet with air and oxidation of the metal. The gas feeding can be carried out as counter flow, vertically to the molten metal jet and in inclined to parallel direction to the molten metal jet. Optionally a pulsating up and down movement of the granulation tube (5) may be provided to separate the molten metal jet into drops.

Preferably, the granulation rotating disc (1) is cooled. To avoid precipitations in the granulation tube (5) etc. it can make sense to heat the granulation tube (5). In this embodiment, the granulation tube (5) is equipped with a blind flange. So it is easy to produce a high pressure and the molten material can be let out quickly. In another embodiment, the granulation tube (5) is returned back to the melting furnace (3) whereby a regular mixing of the melt and a high reproducibility of the particle composition are guaranteed. In many cases, it makes sense to envisage a conveying pump in/at the melting furnace (3) to convey the molten metal to/into the granulation tube (5).

A process according to the invention for the production of spherical metal particles of higher dimensions and higher spherical uniformity comprises the following steps:

Melting of the metal starting material;

Conveying of the molten metal into a granulation tube equipped with at least one melt outlet for the melt stream;

Dispersing of the molten metal into small spheroid droplets by conducting at least one molten metal jet from the granulation tube onto a rotating disc under protective atmosphere;

Cooling and supporting the separation of the metal jet into metal droplets by conducting a cooling inert gas into the melt stream, optionally by pulsating up and down movement of the granulation tube (5) and

Cooling and dispersing of the metal droplets by the rotating disc while freezing of these to discrete granulate particles;

Typical metals which are processed in molten state according to the granulation process of this invention because of their high reactivity are selected from the group consisting of Al, Mg, Ca, Zn and their alloys—the process can also be applied for other metals.

Because of the high reactivity of the metal melt it makes sense to carry out the melting of the metal and the handling of the molten metal in a controlled gas atmosphere. Also the cooling process of the dispersed droplets by gas is preferably carried out by predetermined cooling gas comprising one or more inert gases in an open or closed granulation chamber 20 which offers this controlled atmosphere.

By the process according to the invention the production of spherical particles of fine grain structure of high shape and dimension uniformity from the melt is possible. Such particles having a fine grain structure are particularly suitable for applications like thixomolding, sintering, metal injection molding and similar powder metallurgic processes.

The process according to the invention is particularly applicable for the production of granulate from magnesium or magnesium alloys.

### DEFINITIONS

In the following metal is meant to include the respective alloys and the metal having a low level of impurities.

Spheroid means all kind of round shape like for example spheres, lens shapes, elliptic shapes, etc. which have no sharp or angular edges.

Since the production of granulate is carried out directly from the melt by dropping of the melt from the openings onto a rotating disc, additional machining is unnecessary so to avoid expense. In addition, a very unitary grain distribution can be reached with a round to lens shaped grain shape, for which until now time-consuming separation processes were necessary and also much scrap was produced. Therefore, according to the invention waste is avoided and processing steps can be spared.

In case of very ignoble metals like magnesium or calcium, and/or their alloys known rotating disc processes could not be easily transferred to these metals, but particular provisions must be taken to protect the very reactive molten metal in particular in case of melting crucibles with a great surface.

According to the invention any access of gases reacting with the melt, like vapor, oxygen, nitrogen is preferably avoided. To this end melting takes place under a protective cover or atmosphere and transport of the melt takes place via a closed pipe system to the outlets or nozzles.

Subsequently the invention is explained in detail on basis of magnesium alloys, but it is also suitable for other highly reactive metals in the melt.

A variety of gases are suitable for use in the furnace itself, either inert gas or reactive gas, such as mixtures of dry air, nitrogen or carbon monoxide with sulfur dioxide, sulfur hexafluoride or R134a, above the melt, which leads to the formation of a protective layer on top of the melt surface. The transport pipe carrying liquid metal from the melting furnace to the atomization station, is heated to avoid deposits of magnesium or its compounds by heat convection inside the transport pipe whereas a very equal heat distribution along the pipe is to be observed. Respective measures are known to the expert. In the process the melt can be circulated, what causes continuous return flow of melt into the melting furnace, which was not discharged onto the rotating plate, and thus permanent mixing of the melt volume leads to the provision of a good homogeneity of the product and homogenous temperature distribution. Advantageous is the high flow rate inside the pipe, so that impurities (e.g. oxides) are permanently transported and cannot be deposited inside the pipe and block it.

It is also possible to work with a granulation pipe without return flow, which leads to higher pressures inside the pipe with higher flow rates.

Also possible are hybrid types, where the return flow of the melt into the melting furnace is decelerated by a valve and in this way the pressure in the granulation pipe at the outlets and/or nozzles can be regulated. The pressure at the outlet openings can also be regulated dynamically during the granulation process in this way, which avoids blocking the outlets and/or can dissolve already formed deposits. When using a metal pump such pressure regulation can be effected via a valve at the return flow and additionally via the delivery rate of the pump.

The pipe itself can be heated on the entire surface or only partly, e.g. only in the lower section, to increase convection in that part and to avoid deposits of reaction products of the melt.

For the formation of particles the differences in speed between the droplet and the surrounding gas have to be considered. Furthermore, shape and size of the particles is affected by density, viscosity, surface tension and diameter of the jet escaping from the outlet (nozzle diameter, nozzle material).

With increasing speed the following occurs: drip-off, Rayleigh disintegration, wave disintegration, atomization (these terms are explained in Schubert, Handbuch der mechanischen Verfahrenstechnik, Vol., published by Wiley VCH, 2001, which is referred to for avoiding repetitions). The dependence of the droplet size was already calculated by Schmidt (Schmidt, P.: “Zerstäuben von Flüssigkeiten”—Übersichtsvortrag Apparatetechnik, Essen University 1984, which is referred to as well). The maximum static pressure, which a droplet can withstand before disintegration, was calculated by Schmit in 1984 and Bauck in 2000 (Vauck, W. R. A.: Grundoperationen chemischer Verfahrenstechnik, DVG-Verlag, 11^{th} Edition, 2000, which is referred to as well). Rayleigh disintegration occurs, as soon as the dynamic pressure exceeds the static pressure. Therefore the droplet size for certain alloys and plant parameters can be calculated and the particle size can be partly controlled.

A problem is that it was also observed that the outlet nozzles are blocked from the outside, with the metal melt being discharged from the nozzle, deposits are formed. For this reason the formation of oxides, nitrides, etc. must be avoided. This can be achieved by working under inert gas. For a completely encapsulated plant any inert gas is possible; for (partly) open plants the inert gas should be lighter than air and in this way is guided against the falling droplets, so that the access of unwanted gases such as oxygen/nitrogen to the nozzles, which leads to the formation of unwanted deposits, can be avoided. This can be achieved for open chambers, in which the metal drops into the light inert gas, e.g., by guiding sheets at the granulation pipe.

But, it is also important to avoid the formation of unwanted compounds already in the melting furnace—either by selection of a suitable crucible material, as is known to the expert, which cannot be etched by the melts, or by filtration upstream of the melt delivery pump, which holds back coarse particles.

It is especially surprising that the particle size variation for the invented process is small, which can be achieved in machining processes only by extensive further sieving/screening operational steps.

With the production of spheroid particles according to the invention it was observed that the process with less producing efforts provides particles with the same or better characteristics with thixo molding as traditionally produced granulate by machining and grain fractionation.

With the invented process, among others, the following advantages are achieved:

1) Low producing costs by saving on machining

2) Less waste compared to machining (the ingots cannot be cut completely)

3) Sparing fractioning steps

4) Reduction of abrasion changing the conveying and reaction characteristics of the particles, which is created during transport of the machined sharp-edged granulate, by round shape

5) Finer micro structure of the granulate particles with correspondingly better characteristics of components produced with the granulate.

Selecting the connections between equipment and processes according to the invention allows the manufacture of reasonably round, spheroid, elliptical or lentoid particles of different sizes and multiple applicability, such as sintering, thixo molding (metal injection molding) pressing, etc.

The invention provides processes, apparatus and systems for the manufacture of granulate particles of even spheroid shape and high sphericity, consisting of metal and its alloys, by the use of an ameliorated rotating disc plant.

In the following the invention is explained in detail, using embodiments, which only serve to explain and are non-limiting together with the accompanying drawings.

### BRIEF DESCRIPTION OF THE DRAWINGS

FIG. 1 shows an embodiment of the plant according to the invention with the granulation apparatus;

FIGS. 2A & 2B show a structure of a mechanical granulate and a melt-metallurgically produced granulate (AZ 91).

FIGS. 3A & 3B schematically show different embodiments of the transport pipe

FIG. 4 shows a granulate of the magnesium alloy AZ91 produced according to the invention.

### DETAILED DESCRIPTION OF THE INVENTION

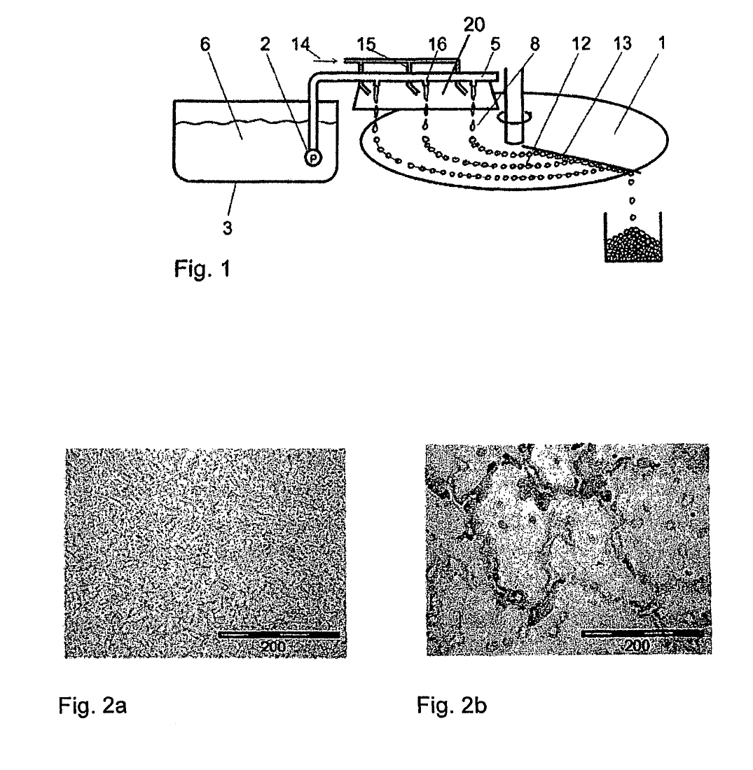

In FIG. 1 the plant according to the invention is schematically represented. From a melting furnace 3 by means of a delivery pump 2 melt 6 is led into the granulation pipe 5 with nozzles 16. The melt exits from the nozzles 16 into the granulation chamber filled with inert gas 20 and forms droplets 8. The droplets fall onto the rotating disc 1, solidify to particles 12 and are guided by the deflector 13 into a container 2. Inert gas 14 is guided through pipes 15 to the melt escaping from the nozzles 16, which prevents the formation of oxides, nitrides and the like at the nozzles 16 of the granulation pipe 5 and on the granulate particles, and which facilitates the atomization of the melt jet into droplets 8.

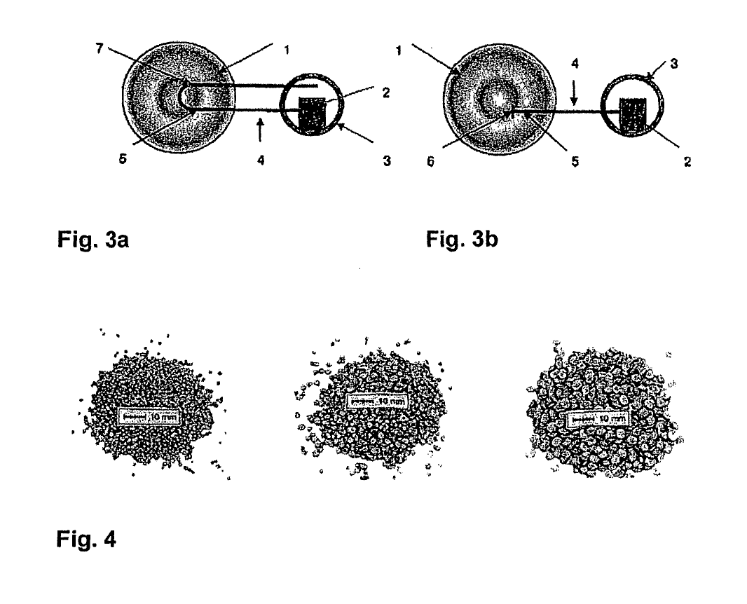

FIG. 3 shows schematically several embodiments of the routing of the granulation pipe 5. In FIG. 3a schematically a granulation apparatus with return flow is shown. Within the routing of the pipe a pump P is arranged, which evenly supplies the melt. The return flow of undischarged melt via the return pipe 7 into the melting furnace is visible. In FIG. 3b, a embodiment without return is represented, where the granulation pipe 5 ends in a blind flange. Here also a pump P exists, which can increase the pressure in granulation pipe 5 for faster melt discharge and which can perform pressure pulses, e.g. for unblocking the nozzles 16.

FIG. 4 shows different granulates from an apparatus according to the invention. The spherical lentoid shape of the Mg granulate, which is made from the melt according to the invention, can clearly be seen.

FIG. 2a shows a photographic image of the micro structure of a cross section through a particle of the magnesium alloy AZ91 made from the melt according to the invention through an optical microscope and FIG. 2b shows the micro structure of a particle of the same alloy machined from ingots. It can clearly be seen that the particles made from the melt solidify quickly and thus have, according to the invention, a noticeably fine grain, which influences positively its mechanical characteristics.

The invention provides processes, apparatus and systems for the production of metal granulate, where the particles have an even spheroid shape—as can be seen in FIG. 4.

To this end at least one jet of the molten metal scattering into droplets is directed on a rotating disc. The melt jet is blown against with inert gas, in this case mainly helium. A dome made of deflector plates underneath the granulation pipe prevents, as a granulation chamber, the inert gas from flowing off and keeps an atmosphere, which prevents oxidation of the melt escaping from the nozzles. The droplets impinge on the cold, possibly cooled, rotating disc. The rotating disc absorbs the heat from the melt droplet so fast, that the melt quickly solidifies to a granulate particle with fine-grain micro structure. The rotation prevents collision/coalescence of the droplets and guarantees in this way a solidification of the droplets to discrete particles. The particles are moved by a deflector over the edge of the disc into a container. Other apparatus for removing the solidified particles are possible, such as brushes, blowers, etc.

In this embodiment the pressure in the granulation pipe 5 is created by a centrifugal pump. In general all known pumping processes and systems are suitable to create the melt pressure and/or the melt flow in the pouring tube, such as piston pumps, induction pumps, pneumatic pumping systems, but also for pressurization of the melting furnace interior and pump-free feed systems, which e.g., work according to principle of the communicating vessels, can be used.

Shape and size of the granulate particles can be manipulated by different apparatus parameters. These are, among others, the distance of the pouring tube from the rotating disc, the melt pressure, the melt temperature and the embodiment of the granulation pipe (with or without return flow). Furthermore, temperature flow rate, composition and flow angle of the inert gas as well as the temperature of the rotating disc affect the shape and size of the granulate particles. Depending on the parameter combination the shape of the particles is spheroid, disc-shaped, lentoid, ball-shaped or cylindrical. Increasing the rotation speed of the disc, e.g., causes a more elongated shape of the particles.

Before granulating the metallic starting materials, e.g., magnesium pressure die cast scrap, are under an inert gas atmosphere, selected from the group consisting of noble gases such as argon, neon, helium or nitrogen, carbon dioxide or dry air with added sulfur dioxide, sulfur hexafluoride or R134a or mixtures thereof and molten in melting furnace 3. It is also possible to melt while adding salts, which causes the formation of liquid salt on top of the melt bath surface, and in this way, prevents the reaction of the melt with air. For this process step all known protective measures for melts of the respective metal, in this example magnesium or magnesium alloys, are suitable.

One process of the invention to manufacture smaller spheroid particles with fine crystalline composition and highly uniform shape and size includes the following steps:

melting the metallic starting material;

leading the molten metal in a heated granulation pipe over a rotating disc;

discharge of the molten metal from nozzles in the granulation pipe onto the rotating disc;

solidification of the metal on the rotating disc to form spheroid particles; and

embodiments can, e.g., include the following:

1) Separation of the molten metal, which is discharged as a jet from the nozzles in the granulation pipe, into droplets.

2) Discharge of the molten metal from the nozzles under protective gas.

3) Return of the melt flow in the granulation pipe to the melting furnace.

4) Cooling the rotating disc from below, e.g. with water.

Metal powders, which are produced by machining processes are generally often of irregular composition. When dispersing the molten metal the external gas pressure onto the surface of the distributed droplets is preferably atmospheric pressure.

### Example

### Manufacture and Characteristics of Spheroid Mg Particles with Generally Fine Crystalline Characteristics

Magnesium pressure cast scrap of alloy AZ91 is molten in an electrically heated melting furnace under nitrogen with 0.20% R134a at 680° C. Inside the melting furnace is a centrifugal pump, which is feeding the magnesium melt with 5500 rpm into a blind-end, closed, heated granulation pipe with 16 outlet nozzles out of the melting furnace. Beneath the outlet nozzles runs a water-cooled rotating disc. During the discharge of the melt from the nozzles a melt jet forms, which disintegrates at a drop height of 120 mm into droplets. Helium is directed as protective gas against the melt jet. Guiding sheets around the granulation pipe form a dome, which prevents the helium to escape from the top and which form a granulation chamber 20 between granulation pipe and rotating disc for the helium atmosphere to protect the melt from oxidation. Upon impact on the rotating disc the melt droplets solidify to particles, before they are removed from the rotating disc by the rotating movement of the disc from the open granulation chamber 20 formed by the deflectors. The disc rotation depends on the required particle shape at 4-10 rpm. Highly uniform lentoid particles are formed. The particles are fed by a deflector from the rotating disc to a container. Subsequent screening can separate larger, partly not true to size particles. FIG. 4 shows 3 screened fractions of granulates from the magnesium alloy AZ91 produced in this way.

A picture of a cross section by optical microscope of these particles is shown in FIG. 2a in comparison with a cross section of particles from a conventional machining process. It may be seen that the cross section through the cut particles shows significantly larger grains and transitional zones than the fine crystalline structure of the particles produced by the granulation process from the melt.

Therefore, the Mg particles produced according to the invention are superior with respect to their microstructure as well as to their shape to machined particles.

While the invention has been explained in detail by an exemplary embodiment, it is obvious to the expert that different deviations of this teaching are possible within the scope of protection conferred by the appended claims. Thus the scope of protection is restricted by the annexed claims only.

What is claimed is:

1. Apparatus for producing spheroid metal particles with high uniformity in size and shape from a melt with:
a granulation chamber (20), which is mainly filled with inert gas with a closed granulation pipe (5) with at least one melt outlet (16), which feeds the melt to the outlets,
a rotating disc (1) in some distance underneath the melt outlets (16) of the granulation pipe (5), which is driven with selectable speed, so that the molten metal, which is discharged from the melt outlets (5) solidifies in discrete particles on the disc surface; and
a gas-inlet apparatus for the controlled blow of inert gas against the melt being discharged from the outlets and formation of an inert gas atmosphere in the granulation chamber (20).

2. Apparatus according to claim 1, characterised by the granulation rotating disc (1) being cooled.

3. Apparatus according to claim 1, characterised by the granulation pipe (5) being heated.

4. Apparatus according to claim 1, characterised by the granulating pipe (5) possessing a blind flange.

5. Apparatus according to claim 1, characterised by the granulation pipe (5) being returned to the melting furnace (3).

6. Apparatus according to claim 5, characterised by the granulation pipe being equipped with a valve for controlling the flow.

7. Apparatus according to claim 1, characterised by a feed pump being provided on/at the melting furnace (3) for feeding the metal melt to/in the granulation pipe (5).

8. Process for producing spheroid metal particles from a highly reactive metal melt with high uniformity in size and shape from a melt with the help of following steps:
melting of a metallic starting material hermetically sealed without air;
transporting the metal melt in a closed granulation pipe from the melting furnace to at least one melt outlet;
discharge of the melt from the melt outlet above a rotating disc as discrete droplets or melt jet, which disintegrates into droplets before impacting on the rotating disc;
feeding the inert gas into the area where the discharged melt leaves the melt outlet;
collecting the melt on the rotating disc in the form of discrete melt droplets;
solidifying of the melt droplets to granulate particles by contact with the colder surface of the rotating disc; and
guiding the granulate particles for packaging/processing away from the rotating disc.

9. Process according to claim 8, characterised by the starting material of the process being selected from the group consisting of Al, Mg, Ca, Zn and their alloys.

10. Process according to claims 8, characterised by melting the metallic starting material under a controlled gas atmosphere.

11. Process according to claim 8, characterised therein, that the inert gas flow for the melt being discharged from the at least one melt outlet contains helium.

12. Process according to claim 8, characterised by the disintegration of a melt jet being discharged from the at least one melt outlet being supported by a pulsating up and down movement of the granulation pipe.

13. Use of a process according to claim 8, for the manufacture of spheroid particles with fine micro structure and a high uniformity in shape and size from the melt.

14. Process according to claim 8, characterised therein, that the metal is magnesium or a magnesium alloy.

15. Spheroid magnesium particles, produced according to a process according to claim 8.

16. Process according to claims 9, characterised by melting the metallic starting material under a controlled gas atmosphere.

17. Process according to claim 16, characterised therein, that the inert gas flow for the melt being discharged from the at least one melt outlet contains helium.

18. Process according to claim 17, characterised by the disintegration of a melt jet being discharged from the at least one melt outlet being supported by a pulsating up and down movement of the granulation pipe.
